(19) United States
(12) Patent Application Publication
(10) Pub. No.: US 2017/0193832 A1
(43) Pub. Date: Jul. 6, 2017

(54) MULTI-LEARNING INCUBATOR

(71) Applicant: Byungtae KIM, Gangwon-do (KR)

(72) Inventor: Byungtae KIM, Gangwon-do (KR)

(21) Appl. No.: 15/314,237

(22) PCT Filed: Jan. 13, 2015
(86) PCT No.: PCT/KR2015/000304

§ 371 Date: Nov. 28, 2016

(30) Foreign Application Priority Data
May 28, 2014 (KR) 10-2014-0064173

(51) Int. Cl. G09B 5/06; G09B 19/00

(52) U.S. Cl. CPC G09B 5/06; G09B 19/00; A01K 41/00

(57) ABSTRACT

Provided is a multi-learning incubator, which includes: a virtual egg (200) including a case (210) having a shape of an egg as a whole, an egg connector (220) mounted on one side of the case (210) for inputting and outputting data, a memory (230) storing information about a character related to an animal whose egg is hatched, and an egg controller (240) connected to the egg connector (220) and managing input and output data; a main body (110) provided with a seating space (111) in which the virtual egg (200) is placed and a main body connector (112) is disposed wherein the main body connector (112) is electrically connected to the egg connector (220) to input and output data between the virtual egg 200 and the main body (110); a main body controller (120) mounted in the main body (110) and executing a multi-learning program for training and teaching the character of the virtual egg (200); a display (130 disposed at one side of the main body (110) and outputting the character and a predetermined learning image on a screen window (131) according to a control signal of the main body controller (120); and an input unit (140) disposed at the other side of the main body (110) and generating a learner input signal according to a learner's manipulation and inputting the learner input signal to the main body controller (120).

### TECHNICAL FIELD

The present invention relates to a multi-learning incubator, and more particularly, to a multi-learning incubator that generates a character related to an animal in which a virtual egg is hatched by using the virtual egg and cultivates the character through learning activities with a learner, to thereby experience a variety of kinds of learning such as curriculum learning, foreign language learning, and hobby (or cultural life) learning, including hatching learning.

### BACKGROUND ART

Generally, an incubator is a device that hatches eggs artificially. The incubator is provided with an optimal environment necessary for incubating eggs by taking into account various factors that affect the hatching of eggs such as humidity, temperature, and disturbance, in a similar manner to those necessary for mother birds incubating eggs. These incubators are used for learning in kindergartens and schools so that infants and students can acquire information about a hatching process and a hatching principle of the hatching of eggs.

However, in general, when the incubating eggs are placed in the incubator, there is almost no external change during a certain hatching period (about 21 days in the case of eggs), and eggshells are not broken and no external change occurs until the hatching period has elapsed. Accordingly, in the case of users such as young students lacking endurance, the users experience boredom during the hatching period, and thus the interest and learning efficiency of the study on a hatch called a hatching learning are deteriorated.

In addition, in order to confirm to which process of the whole hatching process a current hatching status belongs, when the hatching will be performed, or what the current internal state is, it is necessary to check reference books and the Internet data related to the hatching separately.

Furthermore, when the incubated eggs are aborted while being incubated with a conventional incubator, it can act as a negative factor for young learners who are not psychologically and mentally stable.

In addition, even if the hatching succeeds, there is a problem that the hatching animal may not be managed continuously and may be easily killed, and the hatching animal may be abandoned because of the noise or smell due to the cry or excreta of the hatching animal. Accordingly, the perception of the dignity of life could be erroneously imprinted to the learners whose values are beginning to form.

In addition, in the conventional incubator, only the incubation learning related to the incubation process is possible, and the other functions are not added. As a result, the utilization of the conventional incubator is not high.

Related technology is disclosed in Korean Patent Application Publication No. 10-2007-0034684 (Mar. 29, 2007) entitled an incubator.

### SUMMARY OF THE INVENTION

### Technical Problem

To solve the above problems, it is an object of the present invention to provide a multi-learning incubator that generates a character related to an animal in which a virtual egg is hatched by using the virtual egg and counts time from a point in time when the corresponding character has been generated, to then display a process of cultivating the character in video, text, voice, or dialogue in correspondence to a hatching process in which an actual egg of the corresponding animal is hatched, to thereby teach the hatching process or the hatching principle without worrying about the incubated eggs or animals from being aborted or abandoned.

In addition, it is another object of the present invention to provide a multi-learning incubator capable of maximizing utilization of the incubator by learning various kinds of learning such as curriculum learning, foreign language learning, and hobby (or cultural life) learning, including hatching learning, through characters that will be hatched and cultivated, in which the hatched characters are registered as learner's avatars in a main server, to thereby carry out a lifelong education program, a cultural life program, and a dementia prevention program for the elderly, and allow infants, kids, students, adults, and the elders to acquire learning education or language education information.

### Technical Solution

According to an aspect of the present invention, there is provided a multi-learning incubator comprising: a virtual egg 200 including a case 210 having a shape of an egg as a whole, an egg connector 220 mounted on one side of the case 210 for inputting and outputting data, a memory 230 storing information about a character related to an animal whose egg is hatched, and an egg controller 240 connected to the egg connector 220 and managing input and output data; a main body 110 provided with a seating space 111 in which the virtual egg 200 is placed and a main body connector 112 is disposed wherein the main body connector 112 is electrically connected to the egg connector 220 to input and output data between the virtual egg 200 and the main body 110; a main body controller 120 mounted in the main body 110 and executing a multi-learning program for training and teaching the character of the virtual egg 200; a display 130 disposed at one side of the main body 110 and outputting the character and a predetermined learning image on a screen window 131 according to a control signal of the main body controller 120; and an input unit 140 disposed at the other side of the main body 110 and generating a learner input signal according to a learner's manipulation and inputting the learner input signal to the main body controller 120.

According to another aspect of the present invention, the multi-learning program is a program that counts time from a point in time when the corresponding character has been generated and cultivates the character in correspondence to a hatching process in which an actual egg of the corresponding animal is hatched, and the main body controller 120 controls the display 130 to display photographs, moving images, and animations of the actual egg according to a state of cultivating of the character over time.

According to another aspect of the present invention, the main body 110 further comprises: a microphone 113 for inputting a learner's voice signal; and a speaker 114 for acoustically outputting a voice of the character, an operation state of the multi-learning incubator, and sound effects, and the main body controller 120 further comprises: a voice input control module 122 for extracting predetermined word and sentence information from a learner voice signal inputted through the microphone 113; and a database 121 including and storing answer information for displaying at least one of daily greetings, hatching learning information, curriculum learning information, language learning information, and hobby learning information in an interactive form in correspondence to words and sentences input by the input unit 140 or the voice input control module 122, wherein corresponding answer information is extracted from the database 121 in accordance with the learner input signal inputted through the input unit 140 or the data extracted from the voice input control module 122 and is outputted through the speaker 114.

According to another aspect of the present invention, the virtual egg 200 is electrically connected to an interface connector of any one learner terminal such as a smartphone, a notebook PC, a tablet PC, or a general PC in which the multi-learning program is executed, to thus input and output data between the virtual egg 200 and the one learner terminal to thereby continuously train or teach the stored character in cooperation with the multi-learning incubator through the multi-learning program of the learner terminal.

### Advantageous Effects

According to the present invention, as described above, the following effects may be obtained.

First, a multi-learning incubator according to the present invention generates a character related to an animal in which a virtual egg 200 is hatched by using the virtual egg and counts time from a point in time when the corresponding character has been generated, to then display a process of cultivating the character in video, text, voice, or dialogue in correspondence to a hatching process in which an actual egg of the corresponding animal is hatched, to thereby teach the hatching process or the hatching principle without worrying about the incubated eggs or animals from being aborted or abandoned, and prevent psychologically and mentally negative factors or the perception of the dignity of life from being erroneously imprinted to young learners.

Second, the multi-learning incubator according to present invention trains the character to learn the curriculum learning, language learning, hobby learning, and cultural activity learning necessary for the learner including the above-mentioned hatching learning, and allows the learner to acquire the curriculum learning, language learning, hobby learning, and cultural activity learning necessary for the learner including the above-mentioned hatching learning through the character, to thus provide an education effect for various kinds of learning.

Therefore, it is possible for a learner to acquire various types of learning such as curriculum learning, foreign language learning, hobby and cultural life learning including the above-mentioned hatching learning through the character to be trained, thereby maximizing the utilization of the incubator, and the hatched character is registered as an avatar of the learner in a main server to thus carry out a lifelong education program, a cultural life and a dementia prevention program for the elderly, so that the learner can acquire learning education and language education information for infants, kinds, students, general people and the elderly.

Third, the learner may form emotional sympathy with the character while educating the character through the multi-learning incubator, and the degree of cultivation of the character varies according to the degree of education or management of the character. Therefore, by allowing the learner to focus on learning education, a learning effect may be increased.

Fourth, since learning may be performed in a form that communicates with the character by using the learner input signal input through the input unit or the data extracted from the voice input control module, it is possible to induce the learner to continue to draw interest and fun in learning and to realize an effect of enabling emotional exchange with the character.

### BRIEF DESCRIPTION OF THE DRAWINGS

FIGS. 1 and 2 are perspective views illustrating a configuration of a multi-learning incubator according to a preferred embodiment of the present invention.

FIGS. 3 and 4 are perspective views showing a configuration of a virtual egg according to a preferred embodiment of the present invention.

FIG. 5 is a schematic perspective view showing a configuration in which a virtual egg is connected to a main body controller while being seated on a main body, according to a preferred embodiment of the present invention.

FIG. 6 is a schematic perspective view showing a configuration in which a virtual egg is electrically connected with a learner terminal according to a preferred embodiment of the present invention.

FIG. 7 is a schematic diagram showing a configuration in which a multi-learning incubator and a learner terminal are connected with a main server via a communication network according to a preferred embodiment of the present invention.

FIG. 8 is a schematic diagram for explaining various functions implemented through a main body controller according to a preferred embodiment of the present invention.

### BEST MODE

There is provided a multi-learning incubator comprising:

a virtual egg 200 including a case 210 having a shape of an egg as a whole, an egg connector 220 mounted on one side of the case 210 for inputting and outputting data, a memory 230 storing information about a character related to an animal whose egg is hatched, and an egg controller 240 connected to the egg connector 220 and managing input and output data;

a main body 110 provided with a seating space 111 in which the virtual egg 200 is placed and a main body connector 112 is disposed wherein the main body connector 112 is electrically connected to the egg connector 220 to input and output data between the virtual egg 200 and the main body 110;

a main body controller 120 mounted in the main body 110 and executing a multi-learning program for training and teaching the character of the virtual egg 200;

a display 130 disposed at one side of the main body 110 and outputting the character and a predetermined learning image on a screen window 131 according to a control signal of the main body controller 120; and

an input unit 140 disposed at the other side of the main body 110 and generating a learner input signal according to a learner's manipulation and inputting the learner input signal to the main body controller 120.

### Modes for Embodying the Invention

The objects, features and advantages of the present invention will become more apparent from the following detailed description. Hereinafter, preferred embodiments of the present invention will be described with reference to the accompanying drawings.

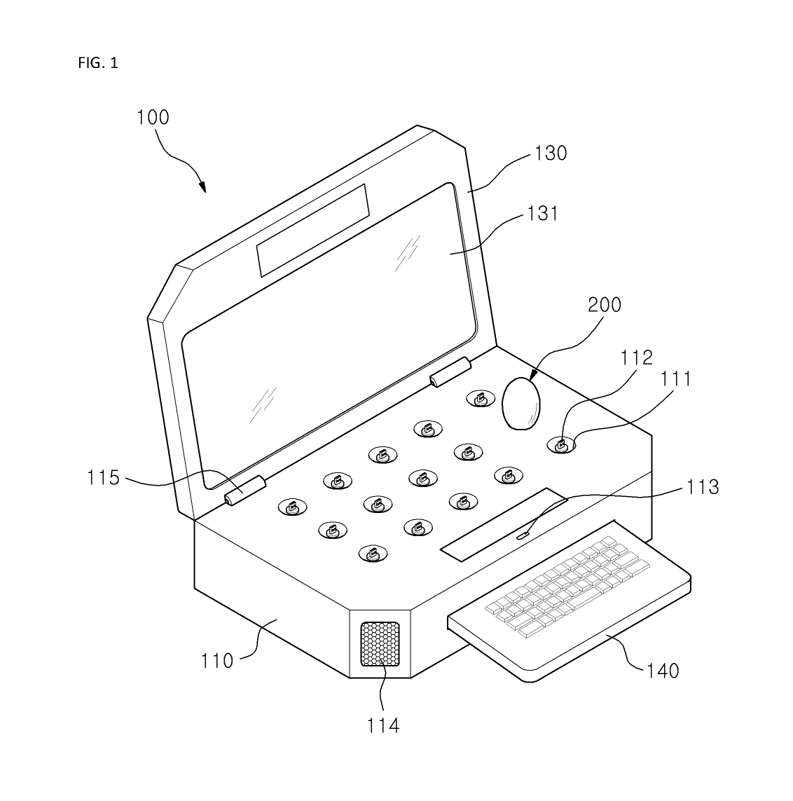

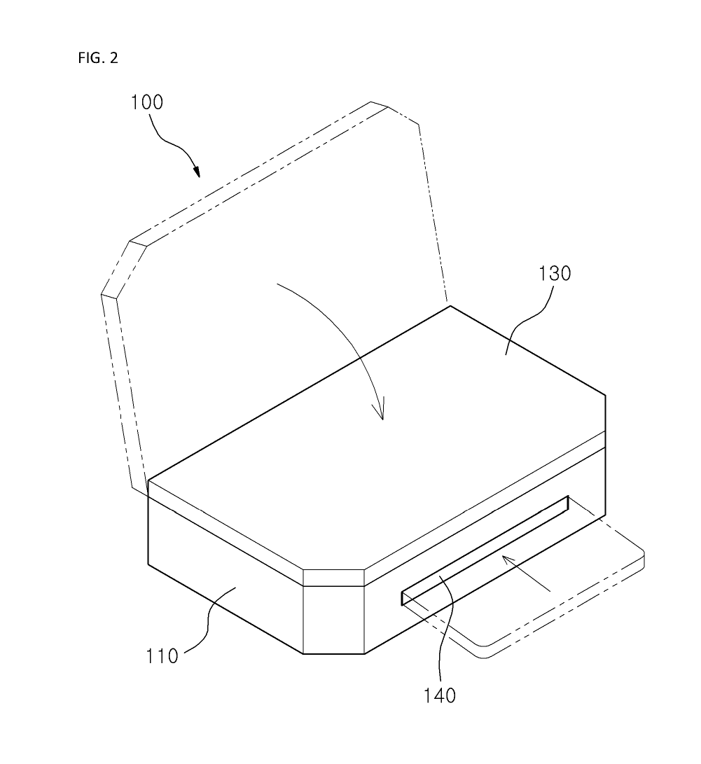

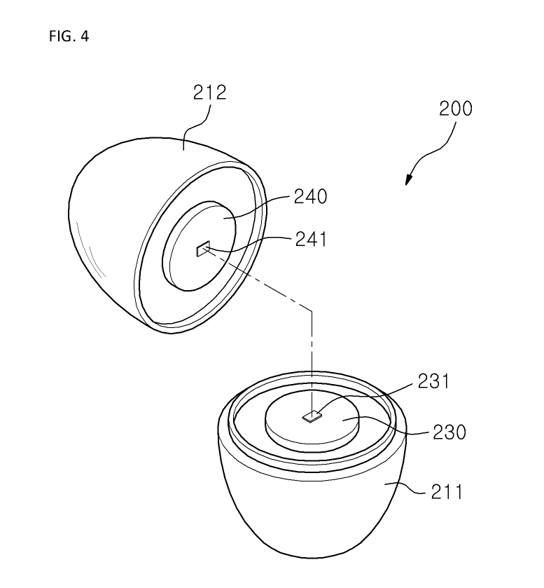

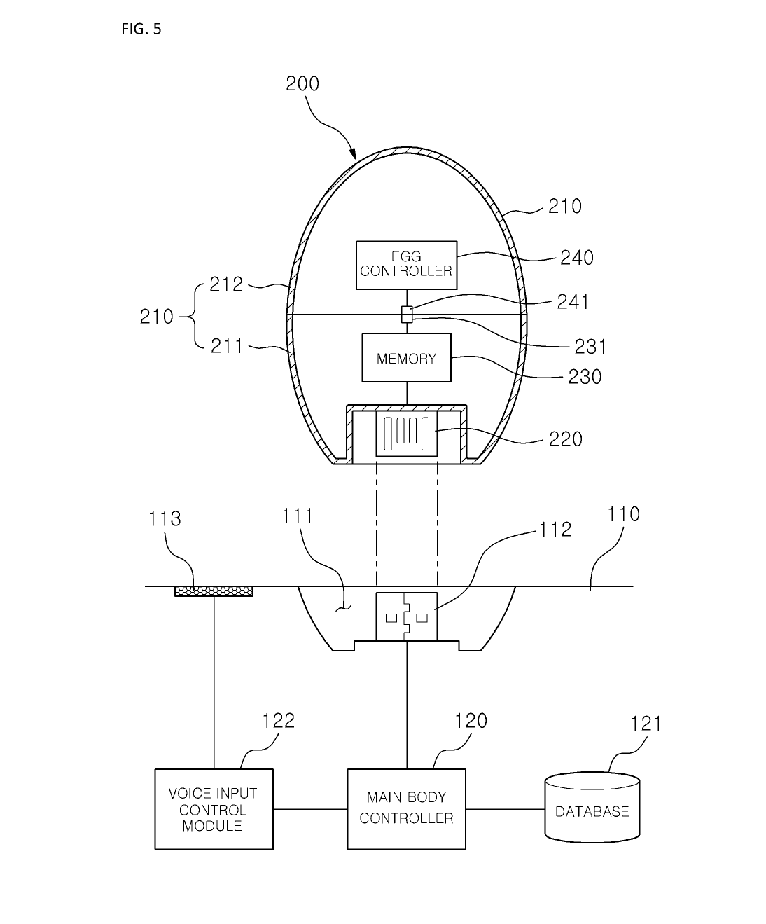

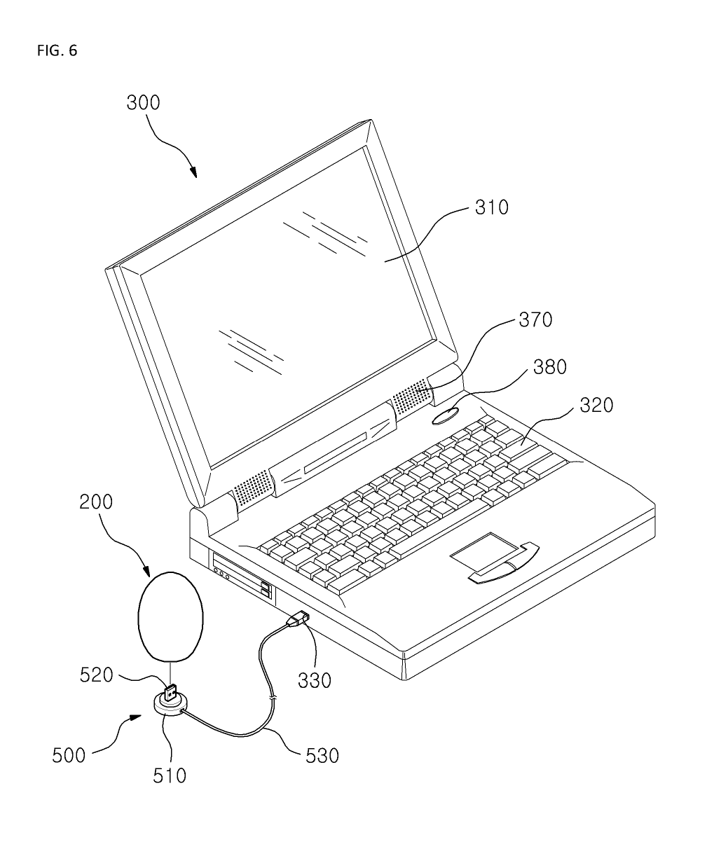

The multi-learning incubator 100 according to the preferred embodiment of the present invention generates a character associated with an animal in which a virtual egg 200 is hatched by using the virtual egg and counts time from a point in time when the corresponding character has been generated, to then display a process of cultivating the character in video, text, voice, or dialogue in correspondence to a hatching process in which an actual egg of the corresponding animal is hatched, to thereby teach the hatching process or the hatching principle without worrying about the incubated eggs or animals from being aborted or abandoned. As shown in FIGS. 1 to 5, the incubator includes the virtual egg 200, a main body 110, a main body controller 120, a display 130, and an input unit 140.

First, the virtual egg 200 includes a case 210 having a shape of an egg as a whole, an egg connector 220 mounted on one side of the case 210 for inputting and outputting data, a memory 230 storing information about a character related to an animal whose egg is hatched, and an egg controller 240 connected to the egg connector 220 and managing input and output data.

Here, the character information may be any animal selected by a learner, and the animal may be a bird, a reptile, a fish, an insect, or the like, hatching through eggs. Also, it is preferable that the egg connector 220 should be a USB connector terminal for interfacing with a learner terminal 300, which will be described later.

In addition, the egg controller 240 is a custom IC, and the egg connector 220 is provided in a USB system of personal information and education system blocking security so that the character and learning information of the learner are not exposed to the outside.

In addition to the data storage space related to the multi-learning according to the present invention, the memory 230 is provided with a storage space in which a learner may store arbitrary data, so that the virtual egg 200 may be used as a portable external memory.

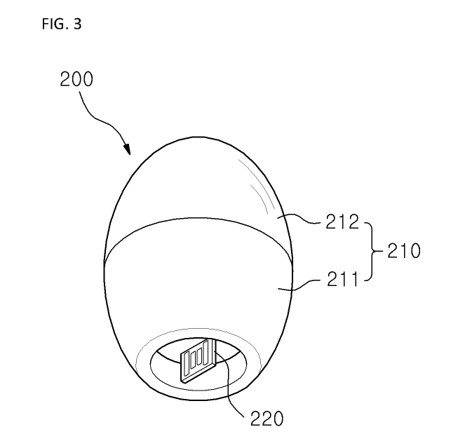

In addition, as shown in FIGS. 3 to 5, the case 210 includes a lower case 211 is disposed at a lower position of the case 210 in which the memory 230 and a memory connector 231 are mounted, and an upper case 212 detachably attached to an upper portion of the lower case 211 in which the egg controller 240 and an egg controller connector 241 are mounted. The memory connector 231 and the egg controller connector 241 are disposed at mutually corresponding positions so that the lower case 211 and the upper case 212 are connected to each other while being electrically connected to each other so that the memory 230 and the egg controller 240 may be mutually connected to signal each other.

As described above, since the case 210 is divided into the lower case 211 and the upper case 212 so that the case 210 can be separated into the lower case 211 and the upper case 212 and assembled with the lower case 211 and the upper case 212 so as to be desorbed from each other when necessary, there is an advantage that maintenance of the egg controller 240 and the memory 230 is facilitated, and the components are easily replaced.

The main body 110 is a body forming a base of the multi-learning incubator, and is provided with a seating space 111 in which the virtual egg 200 may be placed. In the seating space 111 is disposed a main body connector 112 electrically connected to the egg connector 220 for inputting and outputting data between the virtual egg 200 and the main body controller 120.

Although it has been described that the fifteen seating spaces 111 and the fifteen main body connectors 112 are disposed to connect the fifteen virtual eggs 200 in the drawing, the present invention is not limited thereto. However, a single seating space 111 and a single main body connector 112 may be provided for personal use, or three to five seating spaces 111 and three to five main body connectors 112 may be provided for the number of family members to be used for family use. Otherwise, the seating spaces 111 and the main body connectors 112 are disposed for the number of class members to be used for a class.

The main controller 120 is a microcontroller for centrally controlling the driving of the multi-learning incubator according to the preferred embodiment of the present invention, and is mounted in the main body 110, in which a multi-learning program for training and teaching the character of the virtual egg 200 is stored and executed in the main controller 120.

Here, the multi-learning program is a program for counting time from a point in time when a character is generated from an arbitrary virtual egg 200 to cultivate the character in accordance with a hatching process in which an actual egg of a corresponding animal is hatched. The main body controller 120 may control the display 130 to display photographs, moving images, and animations of the actual egg according to the cultivated state of the character over time.

The display 130 may be integrated with the main body 110 as an output device that outputs a character and a learning image related to multi-learning on a screen window 131 according to a control signal of the main body controller 120.

The input unit 140 is an input device that generates a learner input signal according to a learner's manipulation and inputs the learner input signal to the main body controller 120 so that the learner operates the multi-learning incubator 100 or inputs various selections and settings necessary for a learning progress.

In addition, the main body 110 further includes: a microphone 113 for inputting a learner's voice signal; and a speaker 114 for acoustically outputting a voice of the character, an operation state of the multi-learning incubator, and sound effects, and the main body controller 120 further includes: a voice input control module 122 for extracting predetermined word and sentence information from a learner voice signal inputted through the microphone 113; and a database 121 including and storing answer information for displaying at least one of daily greetings, hatching learning information, class learning information, language learning information, and hobby learning information in an interactive form in correspondence to words and sentences input by the input unit 140 or the voice input control module 122.

In addition, the database 121 stores information on an optimal hatching environment for a type of an incubating egg. In addition, the database 121 stores learner basic information that is basically input to share an emotional conversation with a character, such as a learner's name, age, grade, and personality. In addition, the information on the hatching progress status and the scheduled date and time of hatching for each of the incubating eggs, information on the nicknames assigned to the respective incubating eggs, and the like may additionally be stored in the database 121 by the input unit 140.

In addition, the learner input signal inputted through the input unit 140 or the answer information corresponding to the data extracted from the voice input control module 122 is extracted from the database 121 to then be outputted via a speaker 114.

As a result, the learner learns not only the hatching learning related to the hatching process of the eggs, but also acquires the curriculum learning, the language learning, the hobby learning and the cultural activity learning necessary for the learner, during training the character to learn the curriculum learning, the language learning, the hobby learning and the cultural activity learning.

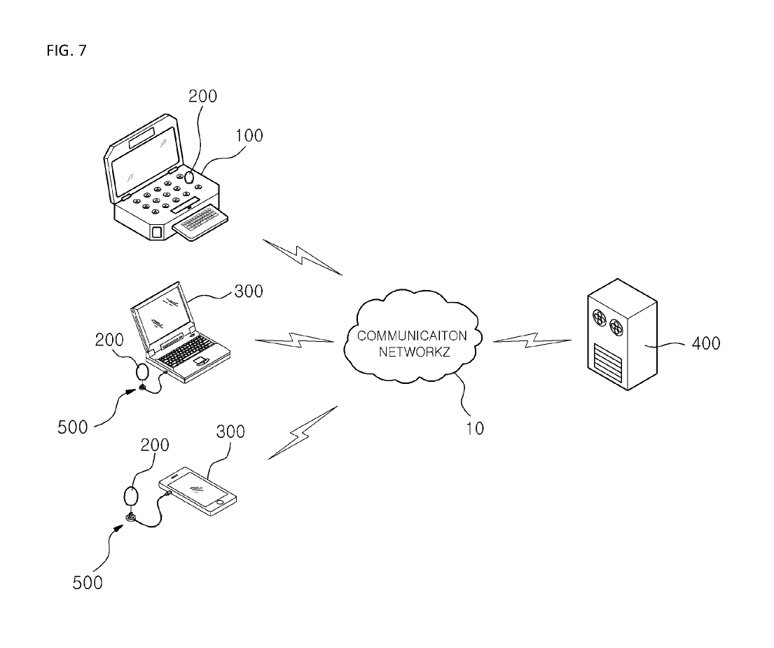

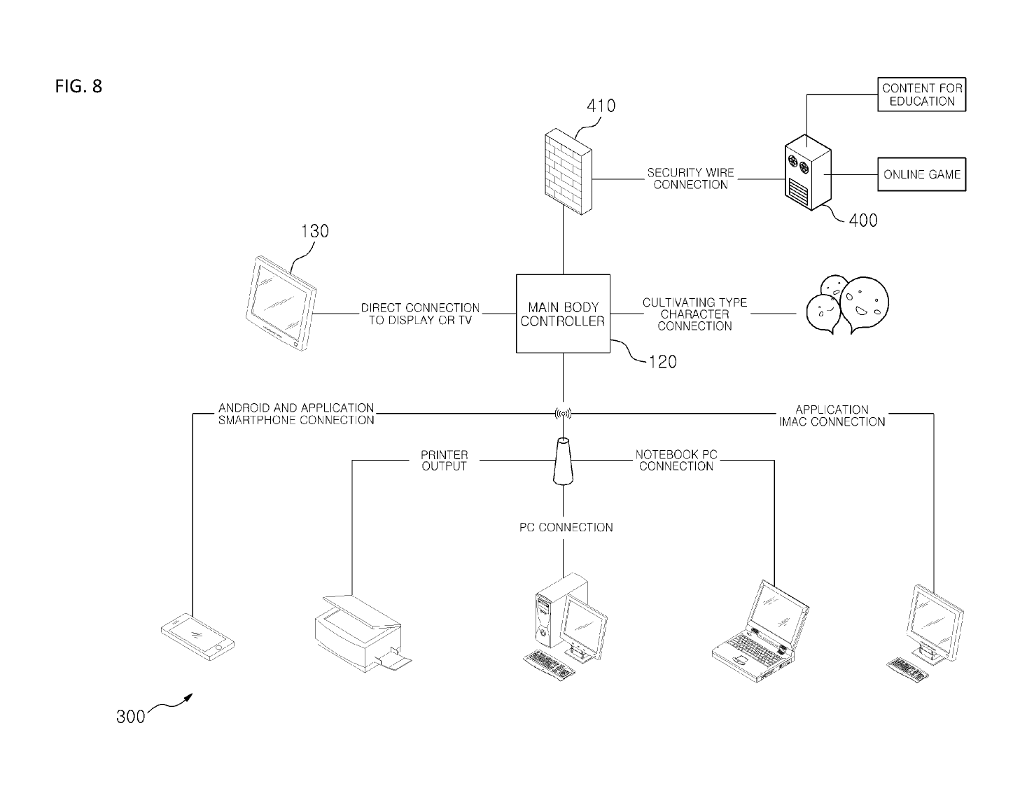

Meanwhile, as shown in FIGS. 7 and 8, the virtual egg 200 according to a preferred embodiment of the present invention is connected to a learner terminal 300 that can be used by a learner, to thus cultivate the character and carry out learning activities, instead of the multi-learning incubator 100.

For this purpose, the virtual egg 200 is electrically connected to an interface connector 360 of any one learner terminal 300 such as a smartphone, a notebook PC, a tablet PC, or a general PC in which the multi-learning program is executed, to thus input and output data between the virtual egg 200 and the one learner terminal 300 to thereby continuously train or teach the stored character in cooperation with the multi-learning incubator 100 through the multi-learning program of the learner terminal 300.

Here, the interface connector 360 may be disposed at the other end of a cable 340 whose one end is connected to a terminal connector 330 disposed at the learner terminal 300. The interface connector 360 is disposed on a support plate 350 that is formed in a plate-shape so that the interface connector 360 is erected and the virtual egg 200 is connected in an upright and seated form. Accordingly, it is possible to prevent the virtual egg 200 having the rounded outer surface from rolling on the bottom surface, and to create an atmosphere in which the virtual egg 200 is stably stuck in a nest.

Various forms of the learner terminals 300 including the multi-learning incubator 100 are connected to the main server 400, which stores the patch program of the multi-learning program, via a wired or wireless communication network 10, to then be patched up. The learner can upgrade or change data or contents of various multi-learning contents including the hatch learning, and form a virtual communication space on the Internet around the main server 400, so that the information share or the sympathy exchange between the learners can be made.

The main server 400 is a server operated by a management company such as a development company, an educational institute or academy, or the like. The main server 400 is connected to the multi-learning incubator 100 or the learner terminal 300 via the communication network 10, and thus character information and various kinds of learning status data created by the learner can be registered and stored in the main server 400.

Therefore, as shown in FIG. 8, the main body controller 120 is directly connected to a TV 130, which can be connected to the display 130 or the multi-learning incubator 100, to display the process of cultivating the character in video, text, voice, or dialogue.

Also, a security program on a network such as a firewall 410 is operated in the main server 400 so that only the registered learner can access the learner's character information and learning information, and prevent personal information from being exposed to the outside.

In addition, a smartphone can be connected to the main body controller 120 through the Android system or an application interlocked with the multi-learning program, to thereby cultivate various characters and progress learning. The PC, the notebook PC, and Apple's iMacs can be connected to the main body controller 120 through an internally installed multi-learning program for signaling each other. In addition, contents of the character information and learning information being cultivated are outputted through a printing unit such as a printer connected to the main body controller 120, so that the learner can check the contents through a printed result.

The main server 400 may store educational contents or store an online game program in addition to various learning information stored in advance, to provide an online game to a learner through the multi-learning incubator 100 and the learner terminal 300.

Meanwhile, in the present embodiment, the virtual egg 200 is wired through a cable with respect to the multi-learning incubator 100 or each learner terminal 300 to input and output data, between the virtual egg 200 and the multi-learning incubator 100 or each learner terminal 300, but the present invention is not limited thereto. When a wireless communication device is installed inside the virtual egg 200, the multi-learning incubator 100, and the learner terminal 300, various data may be input and output through a wireless communicator such as Bluetooth or Wi-Fi.

Next, the operation principle of the multi-learning incubator 100 according to the preferred embodiment of the present invention will be described.

First, when a learner places an arbitrary virtual egg 200 in a seating space 111 of the main body 110, the egg connector 220 and the main body connector 112 are electrically connected to each other. Then, the main body controller 120 detects that the egg connector 220 and the main body connector 112 are electrically connected to each other and then drives the multi-learning program, to then display an initial screen on the display 130.

When a learner selects a kind of an animal to be hatched through the input unit 140 in a driven multi-learning program, a character related to the selected animal is generated, and the generated character information is stored in the memory 230 of the virtual egg 200.

The main body controller 120 recognizes an egg-laying date of the corresponding virtual egg 200 from a point in time of the generation of the character and then checks the timing, to thus determine the information on the hatching progress status and the hatching scheduled date and time of the virtual egg 200. Otherwise, on the basis of the separately inputted egg-laying date information of the virtual incubation egg 200 according to the learner input signal inputted through the input unit 140, information on the hatching progress status and the hatching scheduled date and time of the virtual egg 200.

Therefore, the character can be changed in the state of being cultivated according to the hatching progress state and the hatching scheduled date and time. If the hatching scheduled date and time comes, the eggshell is broken and the character may have a child shape of the animal. The child-shaped character gradually grows according to a degree of the progress of various kinds of learnings by the learner. Also, if the learner's learning progress is insignificant, the character may be restored to the previous growth stage from the growth stage of the present state, or may be raised to a state that is not good healthy.

In addition, the shape for the character may have a virtual character shape generated as a digital image, or may be a shape within an egg of a selected real animal or an actual shape of an animal, which may be displayed through the display 130 and the speaker 114 in the form of still images, moving images, texts, or voices.

Further, the learner may select desired learning information from among various learning categories such as the hatching learning, the curriculum learning, the foreign language learning, and the hobby and cultural life learning provided in the multi-learning program, and may perform the selected learning through the generated character.

For example, when the character may be a teacher teaching learning, and display information related to the learning, so that the learner can acquire the learning. Otherwise, when the learner may be a teacher teaching the character about learning and acquire the learning by inputting learning contents the learner has known.

Meanwhile, the learner is provided for emotional exchange with the character. For example, a learner inputs a term corresponding to a usual greeting “hi?” through the input unit 140 and the microphone 113, the answer information corresponding to the term “hi?” from among the stored answer information is read out, and a term “hi?” is displayed on the screen window 131 or is transferred through the speaker 114 by voice.

In addition, when a learner enters a term “Isn't it hot?” related to a state of an incubation environment element, current temperature information is compared with the virtual current temperature information based on the optimal incubation environment information. When feeling a relatively high temperature value in the result of comparison, a term of guiding an appropriate control of the current incubation environment element such as “I feel a little hot. Do you make it cool?” will be outputted through the screen window 131 or is transferred through the speaker 114 by voice.

Therefore, when the learner inputs the learner input signal for lowering the virtual current temperature through the input unit 140, the virtual current temperature is decreased based on the learner input signal. In this way, if the learner appropriately measures the various hatching environment factors necessary for managing the actual eggs, the character can be fostered at a normal growth rate.

The generated character information and the learning information in progress may be stored in the memory 230 of the virtual egg 200 and the database 121 of the main body controller 120 and may be connected to the main server 400 through the communication network 10 by using the multi-learning incubator 100.

In addition, the learner connects the virtual egg 200 to the learner terminal 300 in which the multi-learning program is run while separating and carrying the virtual egg 200, so as to read the character that have been cultivated up to now, or progress the corresponding learning.

According to the above-described configuration and function of the multi-learning incubator 100 according to the preferred embodiment of the present invention, the multi-learning incubator 100 generates a character related to an animal in which a virtual egg 200 is hatched by using the virtual egg and counts time from a point in time when the corresponding character has been generated, to then display a process of cultivating the character in video, text, voice, or dialogue in correspondence to a hatching process in which an actual egg of the corresponding animal is hatched, to thereby teach the hatching process or the hatching principle without worrying about the incubated eggs or animals from being aborted or abandoned, and prevent psychologically and mentally negative factors or the perception of the dignity of life from being erroneously imprinted to young learners.

In addition, the learner may form emotional sympathy with the character while educating the character through the multi-learning incubator, and the degree of cultivation of the character varies according to the degree of education or management of the character. Therefore, by allowing the learner to focus on learning education, a learning effect may be increased.

Further, since learning may be performed in a form that communicates with the character by using the learner input signal input through the input unit or the data extracted from the voice input control module, it is possible to induce the learner to continue to draw interest and fun in learning and to realize an effect of enabling emotional exchange with the character.

The present invention described above is not limited to the above-described embodiments and the accompanying drawings, and it will be apparent to those skilled in the art that various modifications and variations can be made in the present invention without departing from the spirit or scope of the invention.

### INDUSTRIAL APPLICABILITY

The present invention can be used in learning and gaming industrial fields.

1. A multi-learning incubator comprising:
a virtual egg (200) including a case (210) having a shape of an egg as a whole, an egg connector (220) mounted on one side of the case (210) for inputting and outputting data, a memory (230) storing information about a character related to an animal whose egg is hatched, and an egg controller (240) connected to the egg connector (220) and managing input and output data;
a main body (110) provided with a seating space (111) in which the virtual egg (200) is placed and a main body connector (112) is disposed wherein the main body connector (112) is electrically connected to the egg connector (220) to input and output data between the virtual egg 200 and the main body (110);
a main body controller (120) mounted in the main body (110) and executing a multi-learning program for training and teaching the character of the virtual egg (200);
a display (130 disposed at one side of the main body (110) and outputting the character and a predetermined learning image on a screen window (131) according to a control signal of the main body controller (120); and
an input unit (140) disposed at the other side of the main body (110) and generating a learner input signal according to a learner's manipulation and inputting the learner input signal to the main body controller (120).

2. The multi-learning incubator according to claim 1, wherein the multi-learning program is a program that counts time from a point in time when the corresponding character has been generated and cultivates the character in correspondence to a hatching process in which an actual egg of the corresponding animal is hatched, and the main body controller (120) controls the display (130) to display photographs, moving images, and animations of the actual egg according to a state of cultivating of the character over time.

3. The multi-learning incubator according to claim 2, wherein the main body (110) further comprises: a microphone (113) for inputting a learner's voice signal; and a speaker (114) for acoustically outputting a voice of the character, an operation state of the multi-learning incubator, and sound effects, and the main body controller (120) further comprises: a voice input control module (122) for extracting predetermined word and sentence information from a learner voice signal inputted through the microphone (113); and a database (121) including and storing answer information for displaying at least one of daily greetings, hatching learning information, curriculum learning information, language learning information, and hobby learning information in an interactive form in correspondence to words and sentences input by the input unit (140) or the voice input control module (122), wherein corresponding answer information is extracted from the database (121) in accordance with the learner input signal inputted through the input unit (140) or the data extracted from the voice input control module (122) and is outputted through the speaker (114).

4. The multi-learning incubator according to claim 3, wherein the virtual egg (200) is electrically connected to an interface connector of any one learner terminal such as a smartphone, a notebook PC, a tablet PC, or a general PC in which the multi-learning program is executed, to thus input and output data between the virtual egg (200) and the one learner terminal to thereby continuously train or teach the stored character in cooperation with the multi-learning incubator through the multi-learning program of the learner terminal.
